(19) United States
(12) Patent Application Publication
(10) Pub. No.: US 2010/0191750 A1
(43) Pub. Date: Jul. 29, 2010

(54) Multiple-column bidirectional index

(76) Inventor: A. Leon White, Southfield, MI (US)

Correspondence Address: A. Leon White, P. O. Box 635, Southfield, MI, 48037-0635, US

(21) Appl. No.: 12/657,716

(22) Filed: Jan. 26, 2010

Related U.S. Application Data
(60) Provisional application No. 61/147,727, filed on Jan. 27, 2009.

(51) Int. Cl. G06F 17/30

(52) U.S. Cl. 707/753; 707/E17.083

(57) ABSTRACT

The present invention is a multiple-column index comprised of at least three columns. The columns are repetitious loops of identical content displayed over several pages wherein the relationship between the columns would be consistent. At least two columns have listings in the order of “A” to “Z” beginning at different points of the alphabet. At least one column has listings in “Z” to “A” order. If a search-result is organized on numerous pages, the invention would maximize the potential for discoverability for businesses listed beyond the first page.

### PRIORITY CLAIM

This application claims benefit of Provisional Application 61/147,727.

### BACKGROUND OF INVENTION

Internet advertising mediums such as search engines, directories comparable to YellowPages.com and ThomasNet.com, and other keyword based mediums commonly display numerous pages of search-results in single columns wherein the listings progress alphabetically from “A” to “Z”. If the mediums display secondary columns, they are not of identical content as the primary column but also progress alphabetically from “A” to “Z”. Consequently, listings on pages beyond the first page have diminishing potential for discoverability in comparison to listings on the first page.

### BRIEF SUMMARY OF THE INVENTION

The invention relates to advertising on the Internet wherein businesses seek to maximize the visibility of their websites and/or encourage patronage to their physical addresses to maximize their potential for sales of products and/or services. It would maximize the potential for discoverability for businesses mid-way and at the end of the alphabet to be equal to businesses listed at the beginning of the alphabet regardless to the number listed.

### BRIEF DESCRIPTION OF THE DRAWINGS

FIG. 1 shows a diagram of multiple columns of which two 1 are in the “A” to “Z” order from different points of the alphabet and one 2 is in the reverse order showing “Z” to “A”.

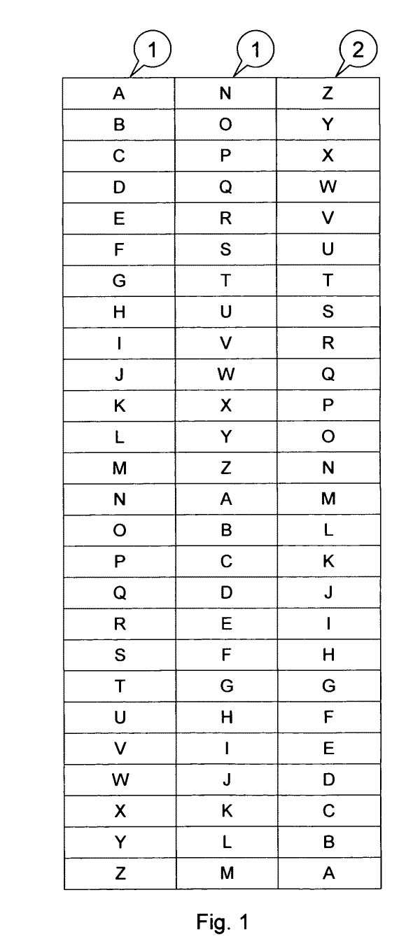

FIG. 2 is an example of the diagram in FIG. 1 displayed on a monitor.

FIG. 3 is the continuation of the alphabetical order of the respective columns in FIG. 2

FIG. 4 is the continuation of the alphabetical order of the respective columns in FIG. 3

FIG. 5 is the continuation of the alphabetical order of the respective columns in FIG. 4 and “A” following “Z” 3 to define a loop.

FIG. 6 is the continuation of the alphabetical order of the respective columns in FIG. 5.

FIG. 7 is the continuation of the alphabetical order of the respective columns in FIG. 6.

FIG. 8 is the continuation of the alphabetical order of the respective columns in FIG. 7 and “A” following “Z” 4 to define a loop in a column with “A” to “Z” order and “Z” following “A” 5 to define a loop in a column with “Z” to “A” order.

FIG. 9 is the continuation of the alphabetical order of the respective columns in FIG. 8.

FIG. 10 is the continuation of the alphabetical order of the respective columns in FIG. 9

FIG. 11 is the continuation of the alphabetical order of the respective columns in FIG. 10.

FIG. 12 is the continuation of the alphabetical order of the respective columns in FIG. 11.

FIG. 13 is the continuation of the alphabetical order of the respective columns in FIG. 12.

FIG. 14 is the continuation of the alphabetical order of the respective columns in FIG. 13.

FIG. 15 is the continuation of the alphabetical order of the respective columns in FIG. 14 and is identical to FIG. 2 to show that the contextual relationship between columns is with identical content is consistent per cycle.

### DETAILED DESCRIPTION OF EMBODIMENT OF THE INVENTION

The invention is a multiple-column bidirectional index comprised of at least three columns. The columns are repetitious loops 3, 4, 5 of identical content. At least two columns 1 have listings in the order of “A” to “Z” beginning at different points of the alphabet. At least one column 2 has listings in “Z” to “A” order. All columns advance uniformly in the same direction. Thus, the contextual relationship between columns is consistent.

The invention provides for businesses listed at the beginning, mid-way, and at the end of the alphabet to be visible simultaneously. Thus, businesses in a column with “A” to “Z” order and beginning with a letter mid-way of the alphabet and businesses in a column with “Z” to “A” order and beginning with “Z” would have the same potential for discoverability as businesses in a column in “A” to “Z” order and beginning with “A”.

The following coding is to demonstrate the embodiment is referenced to the particular images for the invention.

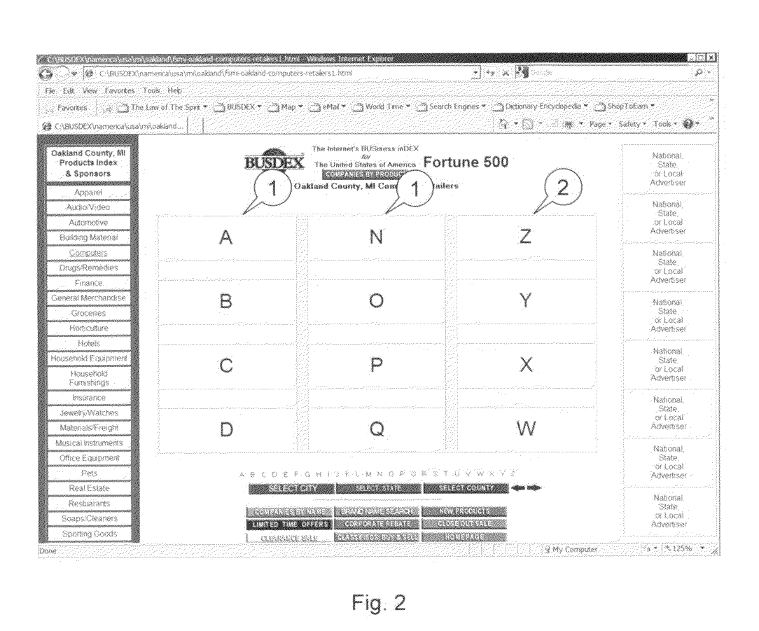

### FIG. 2 Coding

```
<HTML>
<HEAD><TITLE>BUSDEX Page Progressions Fig. 2</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>A</TD>
        <TD BGCOLOR=WHITE WIDTH=295 HEIGHT=77 ALIGN=CENTER
VALIGN=MIDDLE><FONT SIZE=6 FACE=“ARIAL”>N</TD>
        <TD BGCOLOR=WHITE WIDTH=295 HEIGHT=77 ALIGN=CENTER
VALIGN=MIDDLE><FONT SIZE=6 FACE=“ARIAL”>Z</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>B</TD>
        <TD BGCOLOR=WHITE WIDTH=295 HEIGHT=77 ALIGN=CENTER
VALIGN=MIDDLE><FONT SIZE=6 FACE=“ARIAL”>O</TD>
        <TD BGCOLOR=WHITE WIDTH=295 HEIGHT=77 ALIGN=CENTER
VALIGN=MIDDLE><FONT SIZE=6 FACE=“ARIAL”>Y</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>C</TD>
        <TD BGCOLOR=WHITE WIDTH=295 HEIGHT=77 ALIGN=CENTER
VALIGN=MIDDLE><FONT SIZE=6 FACE=“ARIAL”>P</TD>
        <TD BGCOLOR=WHITE WIDTH=295 HEIGHT=77 ALIGN=CENTER
VALIGN=MIDDLE><FONT SIZE=6 FACE=“ARIAL”>X</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>D</TD>
        <TD BGCOLOR=WHITE WIDTH=295 HEIGHT=77 ALIGN=CENTER
VALIGN=MIDDLE><FONT SIZE=6 FACE=“ARIAL”>Q</TD>
        <TD BGCOLOR=WHITE WIDTH=295 HEIGHT=77 ALIGN=CENTER
VALIGN=MIDDLE><FONT SIZE=6 FACE=“ARIAL”>W</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page13.html”><IMG
SRC=“c:/busdex/images/arrow_lt.jpg” ALT=“Back”></A></TD>
    <TD ALIGN=RIGHT><A HREF=“c:/busdex/page2.html”><IMG
SRC=“c:/busdex/images/arrow_rt.jpg” ALT=“Forward”></A></TD>
</TR>
</TABLE>
</DIV>
</BODY>
</HTML>
```

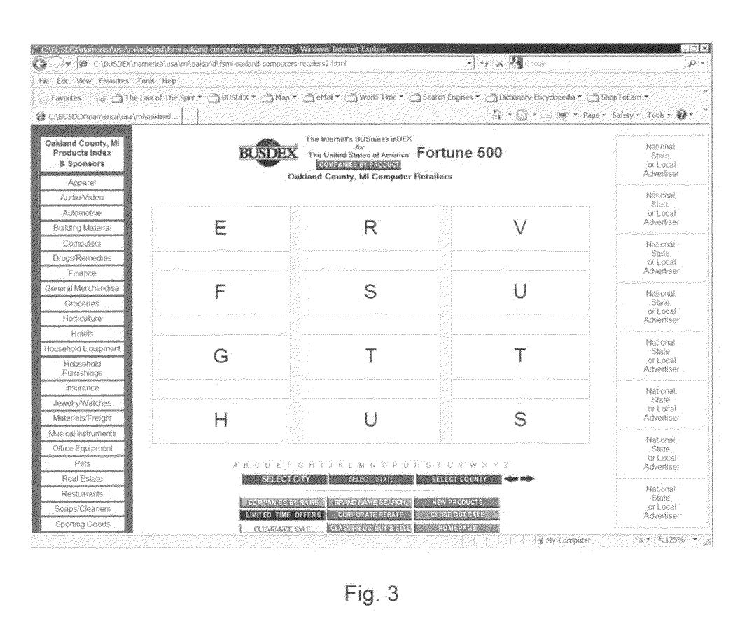

### FIG. 3 Coding

```
<HTML>
<HEAD><TITLE>BUSDEX Page Progressions Fig. 3</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>E</TD>
        <TD BGCOLOR=WHITE WIDTH=295 HEIGHT=77 ALIGN=CENTER
VALIGN=MIDDLE><FONT SIZE=6 FACE=“ARIAL”>R</TD>
        <TD BGCOLOR=WHITE WIDTH=295 HEIGHT=77 ALIGN=CENTER
VALIGN=MIDDLE><FONT SIZE=6 FACE=“ARIAL”>V</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>F</TD>
        <TD BGCOLOR=WHITE WIDTH=295 HEIGHT=77 ALIGN=CENTER
VALIGN=MIDDLE><FONT SIZE=6 FACE=“ARIAL”>S</TD>
        <TD BGCOLOR=WHITE WIDTH=295 HEIGHT=77 ALIGN=CENTER
VALIGN=MIDDLE><FONT SIZE=6 FACE=“ARIAL”>U</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>G</TD>
        <TD BGCOLOR=WHITE WIDTH=295 HEIGHT=77 ALIGN=CENTER
VALIGN=MIDDLE><FONT SIZE=6 FACE=“ARIAL”>T</TD>
        <TD BGCOLOR=WHITE WIDTH=295 HEIGHT=77 ALIGN=CENTER
VALIGN=MIDDLE><FONT SIZE=6 FACE=“ARIAL”>T</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>H</TD>
        <TD BGCOLOR=WHITE WIDTH=295 HEIGHT=77 ALIGN=CENTER
VALIGN=MIDDLE><FONT SIZE=6 FACE=“ARIAL”>U</TD>
        <TD BGCOLOR=WHITE WIDTH=295 HEIGHT=77 ALIGN=CENTER
VALIGN=MIDDLE><FONT SIZE=6 FACE=“ARIAL”>S</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page1.html”><IMG
SRC=“c:/busdex/images/arrow_lt.jpg” ALT=“Back”></A></TD>
    <TD ALIGN=RIGHT><A HREF=“c:/busdex/page3.html”><IMG
SRC=“c:/busdex/images/arrow_rt.jpg” ALT=“Forward”></A></TD>
</TR>
</TABLE>
</DIV>
</BODY>
</HTML>
```

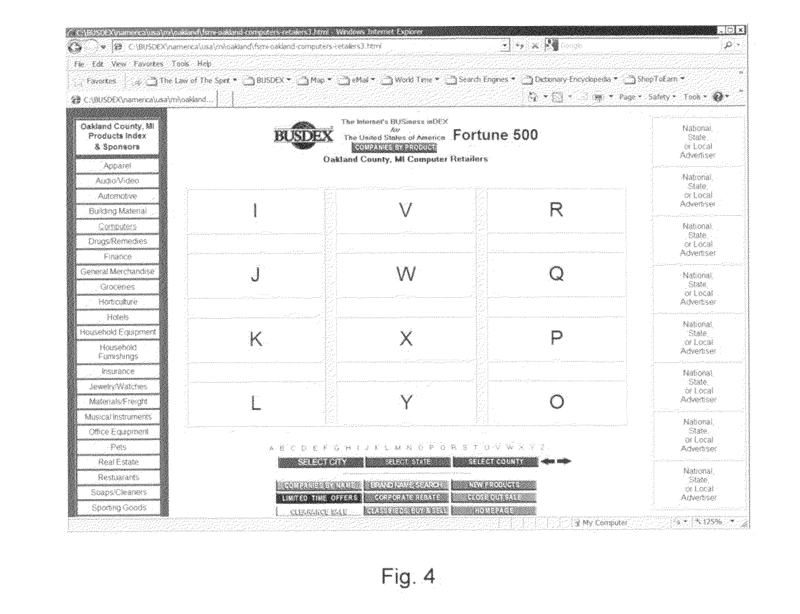

### FIG. 4 Coding

```
<HTML>
<HEAD><TITLE>BUSDEX Page Progressions Fig. 4</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>I</TD>
        <TD BGCOLOR=WHITE WIDTH=295 HEIGHT=77 ALIGN=CENTER
VALIGN=MIDDLE><FONT SIZE=6 FACE=“ARIAL”>V</TD>
        <TD BGCOLOR=WHITE WIDTH=295 HEIGHT=77 ALIGN=CENTER
VALIGN=MIDDLE><FONT SIZE=6 FACE=“ARIAL”>R</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>J</TD>
        <TD BGCOLOR=WHITE WIDTH=295 HEIGHT=77 ALIGN=CENTER
VALIGN=MIDDLE><FONT SIZE=6 FACE=“ARIAL”>W</TD>
        <TD BGCOLOR=WHITE WIDTH=295 HEIGHT=77 ALIGN=CENTER
VALIGN=MIDDLE><FONT SIZE=6 FACE=“ARIAL”>Q</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>K</TD>
        <TD BGCOLOR=WHITE WIDTH=295 HEIGHT=77 ALIGN=CENTER
VALIGN=MIDDLE><FONT SIZE=6 FACE=“ARIAL”>X</TD>
        <TD BGCOLOR=WHITE WIDTH=295 HEIGHT=77 ALIGN=CENTER
VALIGN=MIDDLE><FONT SIZE=6 FACE=“ARIAL”>P</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>L</TD>
        <TD BGCOLOR=WHITE WIDTH=295 HEIGHT=77 ALIGN=CENTER
VALIGN=MIDDLE><FONT SIZE=6 FACE=“ARIAL”>Y</TD>
        <TD BGCOLOR=WHITE WIDTH=295 HEIGHT=77 ALIGN=CENTER
VALIGN=MIDDLE><FONT SIZE=6 FACE=“ARIAL”>O</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page2.html”><IMG
SRC=“c:/busdex/images/arrow_lt.jpg” ALT=“Back”></A></TD>
    <TD ALIGN=RIGHT><A HREF=“c:/busdex/page4.html”><IMG
SRC=“c:/busdex/images/arrow_rt.jpg” ALT=“Forward”></A></TD>
</TR>
</TABLE>
</DIV>
</BODY>
</HTML>
```

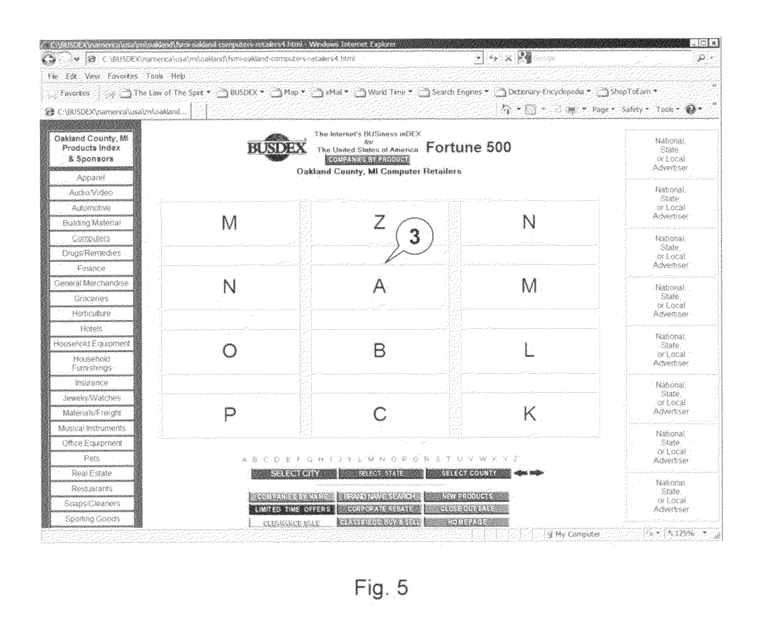

### FIG. 5 Coding

```
<HTML>
<HEAD><TITLE>BUSDEX Page Progressions Fig. 5</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>M</TD>
        <TD BGCOLOR=WHITE WIDTH=295 HEIGHT=77 ALIGN=CENTER
VALIGN=MIDDLE><FONT SIZE=6 FACE=“ARIAL”>Z</TD>
        <TD BGCOLOR=WHITE WIDTH=295 HEIGHT=77 ALIGN=CENTER
VALIGN=MIDDLE><FONT SIZE=6 FACE=“ARIAL”>N</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>N</TD>
        <TD BGCOLOR=WHITE WIDTH=295 HEIGHT=77 ALIGN=CENTER
VALIGN=MIDDLE><FONT SIZE=6 FACE=“ARIAL”>A</TD>
        <TD BGCOLOR=WHITE WIDTH=295 HEIGHT=77 ALIGN=CENTER
VALIGN=MIDDLE><FONT SIZE=6 FACE=“ARIAL”>M</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>O</TD>
        <TD BGCOLOR=WHITE WIDTH=295 HEIGHT=77 ALIGN=CENTER
VALIGN=MIDDLE><FONT SIZE=6 FACE=“ARIAL”>B</TD>
        <TD BGCOLOR=WHITE WIDTH=295 HEIGHT=77 ALIGN=CENTER
VALIGN=MIDDLE><FONT SIZE=6 FACE=“ARIAL”>L</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>P</TD>
        <TD BGCOLOR=WHITE WIDTH=295 HEIGHT=77 ALIGN=CENTER
VALIGN=MIDDLE><FONT SIZE=6 FACE=“ARIAL”>C</TD>
        <TD BGCOLOR=WHITE WIDTH=295 HEIGHT=77 ALIGN=CENTER
VALIGN=MIDDLE><FONT SIZE=6 FACE=“ARIAL”>K</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page3.html”><IMG
SRC=“c:/busdex/images/arrow_lt.jpg” ALT=“Back”></A></TD>
    <TD ALIGN=RIGHT><A HREF=“c:/busdex/page5.html”><IMG
SRC=“c:/busdex/images/arrow_rt.jpg” ALT=“Forward”></A></TD>
</TR>
</TABLE>
</DIV>
</BODY>
</HTML>
```

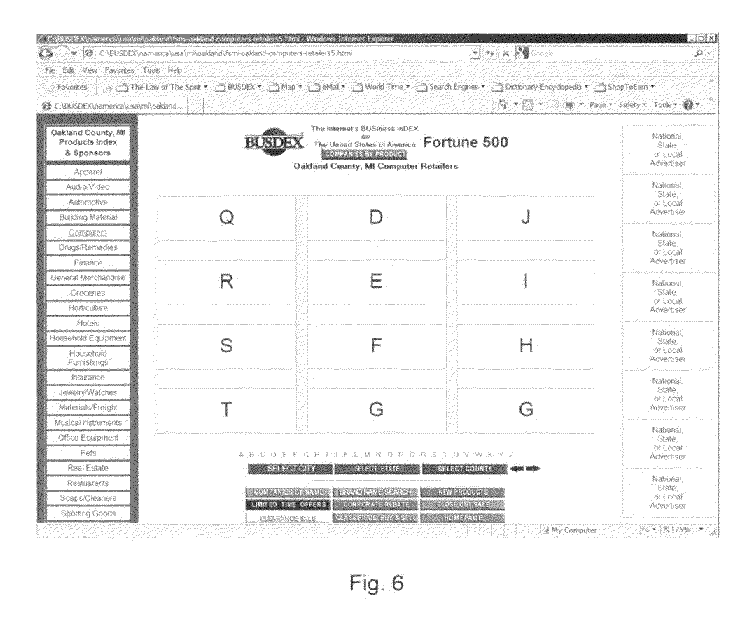

### FIG. 6 Coding

```
<HTML>
<HEAD><TITLE>BUSDEX Page Progressions Fig. 6</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>Q</TD>
        <TD BGCOLOR=WHITE WIDTH=295 HEIGHT=77 ALIGN=CENTER
VALIGN=MIDDLE><FONT SIZE=6 FACE=“ARIAL”>D</TD>
        <TD BGCOLOR=WHITE WIDTH=295 HEIGHT=77 ALIGN=CENTER
VALIGN=MIDDLE><FONT SIZE=6 FACE=“ARIAL”>J</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>R</TD>
        <TD BGCOLOR=WHITE WIDTH=295 HEIGHT=77 ALIGN=CENTER
VALIGN=MIDDLE><FONT SIZE=6 FACE=“ARIAL”>E</TD>
        <TD BGCOLOR=WHITE WIDTH=295 HEIGHT=77 ALIGN=CENTER
VALIGN=MIDDLE><FONT SIZE=6 FACE=“ARIAL”>I</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>S</TD>
        <TD BGCOLOR=WHITE WIDTH=295 HEIGHT=77 ALIGN=CENTER
VALIGN=MIDDLE><FONT SIZE=6 FACE=“ARIAL”>F</TD>
        <TD BGCOLOR=WHITE WIDTH=295 HEIGHT=77 ALIGN=CENTER
VALIGN=MIDDLE><FONT SIZE=6 FACE=“ARIAL”>H</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>T</TD>
        <TD BGCOLOR=WHITE WIDTH=295 HEIGHT=77 ALIGN=CENTER
VALIGN=MIDDLE><FONT SIZE=6 FACE=“ARIAL”>G</TD>
        <TD BGCOLOR=WHITE WIDTH=295 HEIGHT=77 ALIGN=CENTER
VALIGN=MIDDLE><FONT SIZE=6 FACE=“ARIAL”>G</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page4.html”><IMG
SRC=“c:/busdex/images/arrow_lt.jpg” ALT=“Back”></A></TD>
    <TD ALIGN=RIGHT><A HREF=“c:/busdex/page6.html”><IMG
SRC=“c:/busdex/images/arrow_rt.jpg” ALT=“Forward”></A></TD>
</TR>
</TABLE>
</DIV>
</BODY>
</HTML>
```

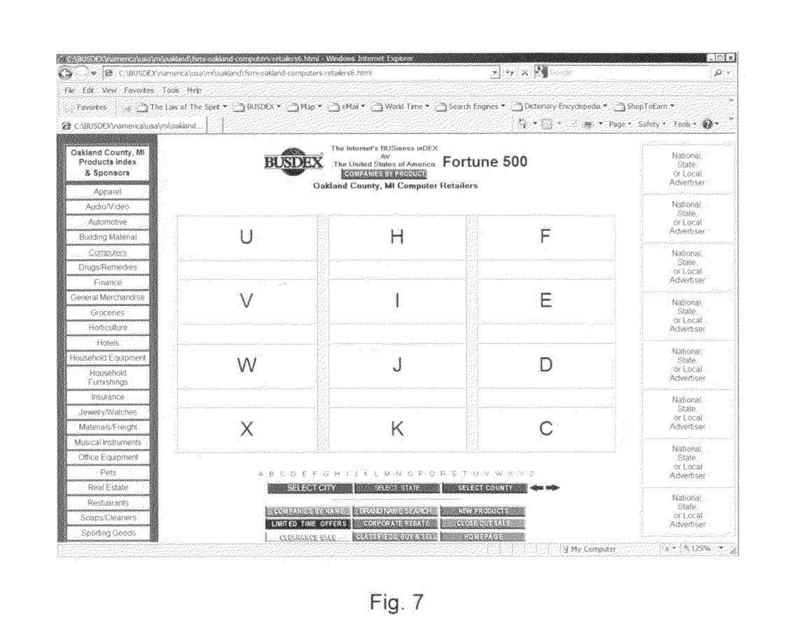

### FIG. 7 Coding

```
<HTML>
<HEAD><TITLE>BUSDEX Page Progressions Fig 7</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>U</TD>
        <TD BGCOLOR=WHITE WIDTH=295 HEIGHT=77 ALIGN=CENTER
VALIGN=MIDDLE><FONT SIZE=6 FACE=“ARIAL”>H</TD>
        <TD BGCOLOR=WHITE WIDTH=295 HEIGHT=77 ALIGN=CENTER
VALIGN=MIDDLE><FONT SIZE=6 FACE=“ARIAL”>F</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>V</TD>
        <TD BGCOLOR=WHITE WIDTH=295 HEIGHT=77 ALIGN=CENTER
VALIGN=MIDDLE><FONT SIZE=6 FACE=“ARIAL”>I</TD>
        <TD BGCOLOR=WHITE WIDTH=295 HEIGHT=77 ALIGN=CENTER
VALIGN=MIDDLE><FONT SIZE=6 FACE=“ARIAL”>E</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>W</TD>
        <TD BGCOLOR=WHITE WIDTH=295 HEIGHT=77 ALIGN=CENTER
VALIGN=MIDDLE><FONT SIZE=6 FACE=“ARIAL”>J</TD>
        <TD BGCOLOR=WHITE WIDTH=295 HEIGHT=77 ALIGN=CENTER
VALIGN=MIDDLE><FONT SIZE=6 FACE=“ARIAL”>D</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>X</TD>
        <TD BGCOLOR=WHITE WIDTH=295 HEIGHT=77 ALIGN=CENTER
VALIGN=MIDDLE><FONT SIZE=6 FACE=“ARIAL”>K</TD>
        <TD BGCOLOR=WHITE WIDTH=295 HEIGHT=77 ALIGN=CENTER
VALIGN=MIDDLE><FONT SIZE=6 FACE=“ARIAL”>C</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page5.html”><IMG
SRC=“c:/busdex/images/arrow_lt.jpg” ALT=“Back”></A></TD>
    <TD ALIGN=RIGHT><A HREF=“c:/busdex/page7.html”><IMG
SRC=“c:/busdex/images/arrow_rt.jpg” ALT=“Forward”></A></TD>
</TR>
</TABLE>
</DIV>
</BODY>
</HTML>
```

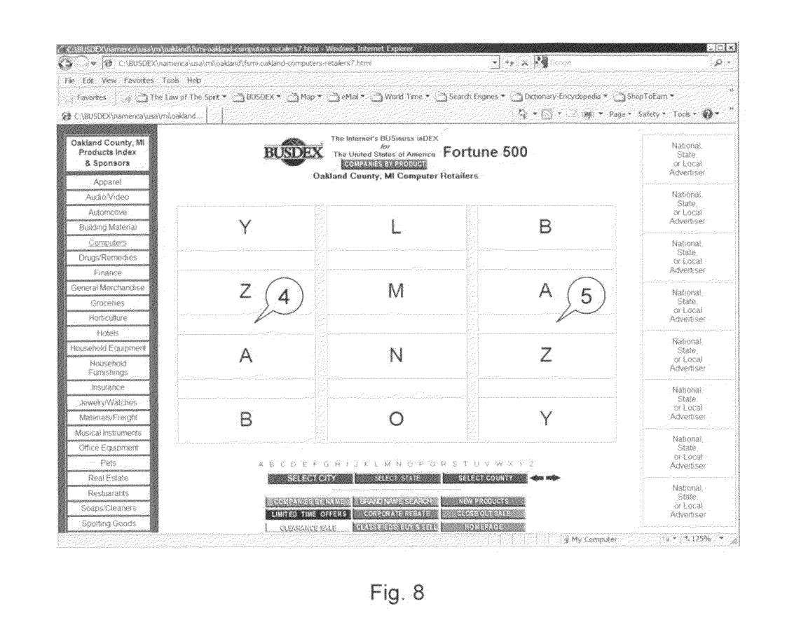

### FIG. 8 Coding

```
<HTML>
<HEAD><TITLE>BUSDEX Page Progressions Fig. 8</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>Y</TD>
        <TD BGCOLOR=WHITE WIDTH=295 HEIGHT=77 ALIGN=CENTER
VALIGN=MIDDLE><FONT SIZE=6 FACE=“ARIAL”>L</TD>
        <TD BGCOLOR=WHITE WIDTH=295 HEIGHT=77 ALIGN=CENTER
VALIGN=MIDDLE><FONT SIZE=6 FACE=“ARIAL”>B</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>Z</TD>
        <TD BGCOLOR=WHITE WIDTH=295 HEIGHT=77 ALIGN=CENTER
VALIGN=MIDDLE><FONT SIZE=6 FACE=“ARIAL”>M</TD>
        <TD BGCOLOR=WHITE WIDTH=295 HEIGHT=77 ALIGN=CENTER
VALIGN=MIDDLE><FONT SIZE=6 FACE=“ARIAL”>A</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>A</TD>
        <TD BGCOLOR=WHITE WIDTH=295 HEIGHT=77 ALIGN=CENTER
VALIGN=MIDDLE><FONT SIZE=6 FACE=“ARIAL”>N</TD>
        <TD BGCOLOR=WHITE WIDTH=295 HEIGHT=77 ALIGN=CENTER
VALIGN=MIDDLE><FONT SIZE=6 FACE=“ARIAL”>Z</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>B</TD>
        <TD BGCOLOR=WHITE WIDTH=295 HEIGHT=77 ALIGN=CENTER
VALIGN=MIDDLE><FONT SIZE=6 FACE=“ARIAL”>O</TD>
        <TD BGCOLOR=WHITE WIDTH=295 HEIGHT=77 ALIGN=CENTER
VALIGN=MIDDLE><FONT SIZE=6 FACE=“ARIAL”>Y</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page6.html”><IMG
SRC=“c:/busdex/images/arrow_lt.jpg” ALT=“Back”></A></TD>
    <TD ALIGN=RIGHT><A HREF=“c:/busdex/page8.html”><IMG
SRC=“c:/busdex/images/arrow_rt.jpg” ALT=“Forward”></A></TD>
</TR>
</TABLE>
</DIV>
</BODY>
</HTML>
```

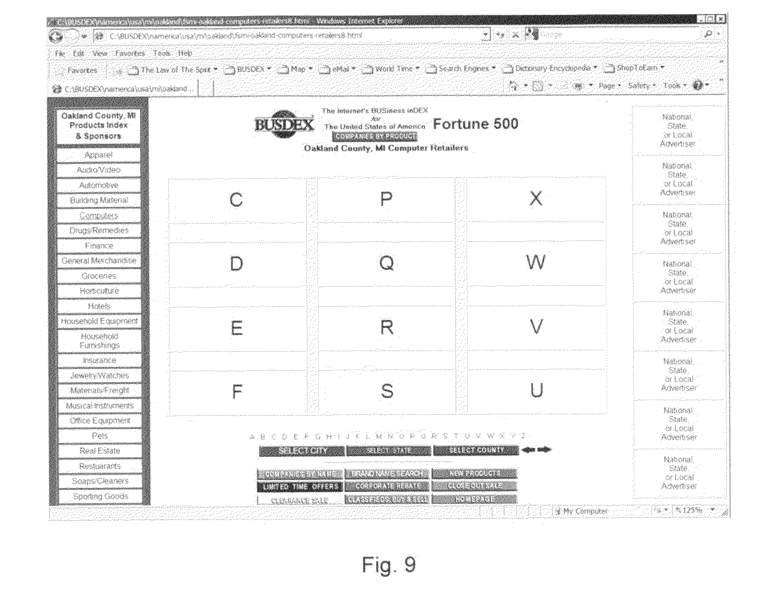

### FIG. 9 Coding

```
<HTML>
<HEAD><TITLE>BUSDEX Page Progressions Fig. 9</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>C</TD>
        <TD BGCOLOR=WHITE WIDTH=295 HEIGHT=77 ALIGN=CENTER
VALIGN=MIDDLE><FONT SIZE=6 FACE=“ARIAL”>P</TD>
        <TD BGCOLOR=WHITE WIDTH=295 HEIGHT=77 ALIGN=CENTER
VALIGN=MIDDLE><FONT SIZE=6 FACE=“ARIAL”>X</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>D</TD>
        <TD BGCOLOR=WHITE WIDTH=295 HEIGHT=77 ALIGN=CENTER
VALIGN=MIDDLE><FONT SIZE=6 FACE=“ARIAL”>Q</TD>
        <TD BGCOLOR=WHITE WIDTH=295 HEIGHT=77 ALIGN=CENTER
VALIGN=MIDDLE><FONT SIZE=6 FACE=“ARIAL”>W</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>E</TD>
        <TD BGCOLOR=WHITE WIDTH=295 HEIGHT=77 ALIGN=CENTER
VALIGN=MIDDLE><FONT SIZE=6 FACE=“ARIAL”>R</TD>
        <TD BGCOLOR=WHITE WIDTH=295 HEIGHT=77 ALIGN=CENTER
VALIGN=MIDDLE><FONT SIZE=6 FACE=“ARIAL”>V</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>F</TD>
        <TD BGCOLOR=WHITE WIDTH=295 HEIGHT=77 ALIGN=CENTER
VALIGN=MIDDLE><FONT SIZE=6 FACE=“ARIAL”>S</TD>
        <TD BGCOLOR=WHITE WIDTH=295 HEIGHT=77 ALIGN=CENTER
VALIGN=MIDDLE><FONT SIZE=6 FACE=“ARIAL”>U</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page7.html”><IMG
SRC=“c:/busdex/images/arrow_lt.jpg” ALT=“Back”></A></TD>
    <TD ALIGN=RIGHT><A HREF=“c:/busdex/page9.html”><IMG
SRC=“c:/busdex/images/arrow_rt.jpg” ALT=“Forward”></A></TD>
</TR>
</TABLE>
</DIV>
</BODY>
</HTML>
```

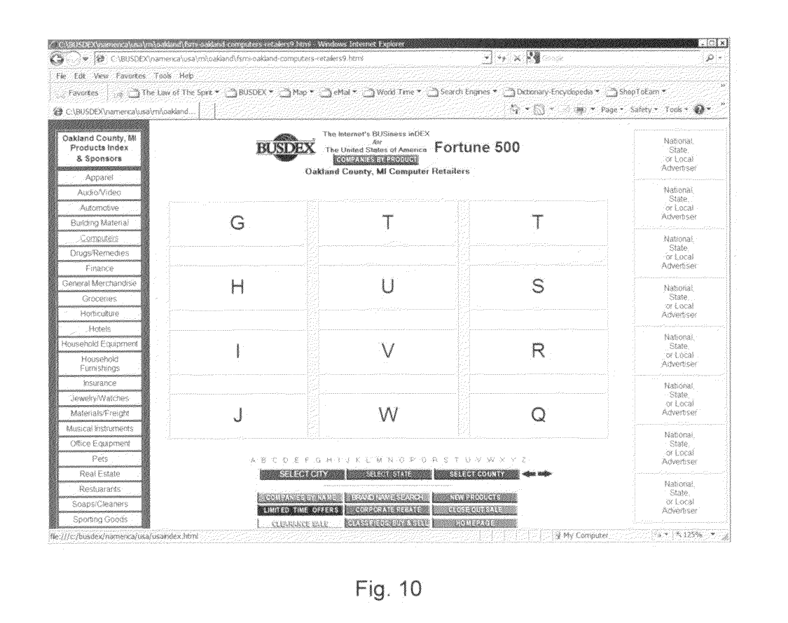

### FIG. 10 Coding

```
<HTML>
<HEAD><TITLE>BUSDEX Page Progressions. Fig 10</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>G</TD>
        <TD BGCOLOR=WHITE WIDTH=295 HEIGHT=77 ALIGN=CENTER
VALIGN=MIDDLE><FONT SIZE=6 FACE=“ARIAL”>T</TD>
        <TD BGCOLOR=WHITE WIDTH=295 HEIGHT=77 ALIGN=CENTER
VALIGN=MIDDLE><FONT SIZE=6 FACE=“ARIAL”>T</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>H</TD>
        <TD BGCOLOR=WHITE WIDTH=295 HEIGHT=77 ALIGN=CENTER
VALIGN=MIDDLE><FONT SIZE=6 FACE=“ARIAL”>U</TD>
        <TD BGCOLOR=WHITE WIDTH=295 HEIGHT=77 ALIGN=CENTER
VALIGN=MIDDLE><FONT SIZE=6 FACE=“ARIAL”>S</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>I</TD>
        <TD BGCOLOR=WHITE WIDTH=295 HEIGHT=77 ALIGN=CENTER
VALIGN=MIDDLE><FONT SIZE=6 FACE=“ARIAL”>V</TD>
        <TD BGCOLOR=WHITE WIDTH=295 HEIGHT=77 ALIGN=CENTER
VALIGN=MIDDLE><FONT SIZE=6 FACE=“ARIAL”>R</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>J</TD>
        <TD BGCOLOR=WHITE WIDTH=295 HEIGHT=77 ALIGN=CENTER
VALIGN=MIDDLE><FONT SIZE=6 FACE=“ARIAL”>W</TD>
        <TD BGCOLOR=WHITE WIDTH=295 HEIGHT=77 ALIGN=CENTER
VALIGN=MIDDLE><FONT SIZE=6 FACE=“ARIAL”>Q</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page8.html”><IMG
SRC=“c:/busdex/images/arrow_lt.jpg” ALT=“Back”></A></TD>
    <TD ALIGN=RIGHT><A HREF=“c:/busdex/page10.html”><IMG
SRC=“c:/busdex/images/arrow_rt.jpg” ALT=“Forward”></A></TD>
</TR>
</TABLE>
</DIV>
</BODY>
</HTML>
```

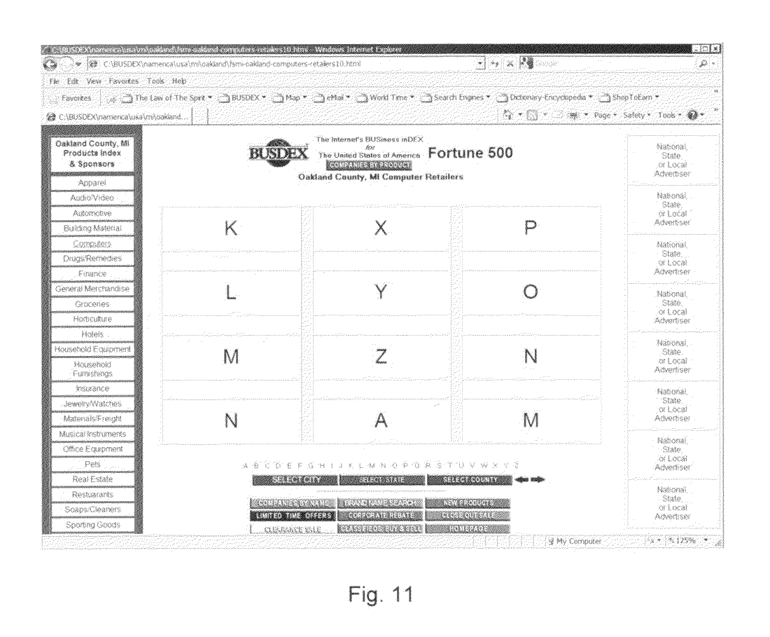

### FIG. 11 Coding

```
<HTML>
<HEAD><TITLE>BUSDEX Page Progressions Fig. 11</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>K</TD>
        <TD BGCOLOR=WHITE WIDTH=295 HEIGHT=77 ALIGN=CENTER
VALIGN=MIDDLE><FONT SIZE=6 FACE=“ARIAL”>X</TD>
        <TD BGCOLOR=WHITE WIDTH=295 HEIGHT=77 ALIGN=CENTER
VALIGN=MIDDLE><FONT SIZE=6 FACE=“ARIAL”>P</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>L</TD>
        <TD BGCOLOR=WHITE WIDTH=295 HEIGHT=77 ALIGN=CENTER
VALIGN=MIDDLE><FONT SIZE=6 FACE=“ARIAL”>Y</TD>
        <TD BGCOLOR=WHITE WIDTH=295 HEIGHT=77 ALIGN=CENTER
VALIGN=MIDDLE><FONT SIZE=6 FACE=“ARIAL”>O</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>M</TD>
        <TD BGCOLOR=WHITE WIDTH=295 HEIGHT=77 ALIGN=CENTER
VALIGN=MIDDLE><FONT SIZE=6 FACE=“ARIAL”>Z</TD>
        <TD BGCOLOR=WHITE WIDTH=295 HEIGHT=77 ALIGN=CENTER
VALIGN=MIDDLE><FONT SIZE=6 FACE=“ARIAL”>N</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>N</TD>
        <TD BGCOLOR=WHITE WIDTH=295 HEIGHT=77 ALIGN=CENTER
VALIGN=MIDDLE><FONT SIZE=6 FACE=“ARIAL”>A</TD>
        <TD BGCOLOR=WHITE WIDTH=295 HEIGHT=77 ALIGN=CENTER
VALIGN=MIDDLE><FONT SIZE=6 FACE=“ARIAL”>M</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page9.html”><IMG
SRC=“c:/busdex/images/arrow_lt.jpg” ALT=“Back”></A></TD>
    <TD ALIGN=RIGHT><A HREF=“c:/busdex/page11.html”><IMG
SRC=“c:/busdex/images/arrow_rt.jpg” ALT=“Forward”></A></TD>
</TR>
</TABLE>
</DIV>
</BODY>
</HTML>
```

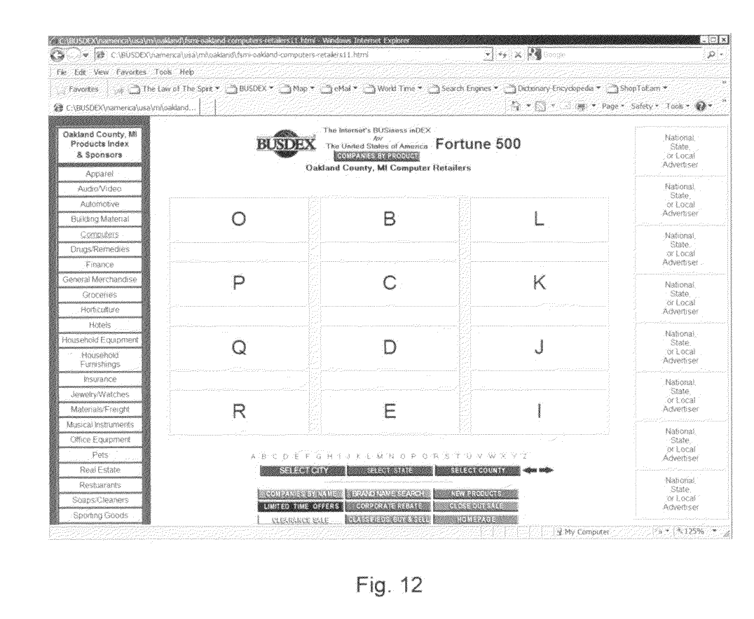

### FIG. 12 Coding

```
<HTML>
<HEAD><TITLE>BUSDEX Page Progressions Fig. 12</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>O</TD>
        <TD BGCOLOR=WHITE WIDTH=295 HEIGHT=77 ALIGN=CENTER
VALIGN=MIDDLE><FONT SIZE=6 FACE=“ARIAL”>B</TD>
        <TD BGCOLOR=WHITE WIDTH=295 HEIGHT=77 ALIGN=CENTER
VALIGN=MIDDLE><FONT SIZE=6 FACE=“ARIAL”>L</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>P</TD>
        <TD BGCOLOR=WHITE WIDTH=295 HEIGHT=77 ALIGN=CENTER
VALIGN=MIDDLE><FONT SIZE=6 FACE=“ARIAL”>C</TD>
        <TD BGCOLOR=WHITE WIDTH=295 HEIGHT=77 ALIGN=CENTER
VALIGN=MIDDLE><FONT SIZE=6 FACE=“ARIAL”>K</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>Q</TD>
        <TD BGCOLOR=WHITE WIDTH=295 HEIGHT=77 ALIGN=CENTER
VALIGN=MIDDLE><FONT SIZE=6 FACE=“ARIAL”>D</TD>
        <TD BGCOLOR=WHITE WIDTH=295 HEIGHT=77 ALIGN=CENTER
VALIGN=MIDDLE><FONT SIZE=6 FACE=“ARIAL”>J</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>R</TD>
        <TD BGCOLOR=WHITE WIDTH=295 HEIGHT=77 ALIGN=CENTER
VALIGN=MIDDLE><FONT SIZE=6 FACE=“ARIAL”>E</TD>
        <TD BGCOLOR=WHITE WIDTH=295 HEIGHT=77 ALIGN=CENTER
VALIGN=MIDDLE><FONT SIZE=6 FACE=“ARIAL”>I</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page10.html”><IMG
SRC=“c:/busdex/images/arrow_lt.jpg” ALT=“Back”></A></TD>
    <TD ALIGN=RIGHT><A HREF=“c:/busdex/page12.html”><IMG
SRC=“c:/busdex/images/arrow_rt.jpg” ALT=“Forward”></A></TD>
</TR>
</TABLE>
</DIV>
</BODY>
</HTML>
```

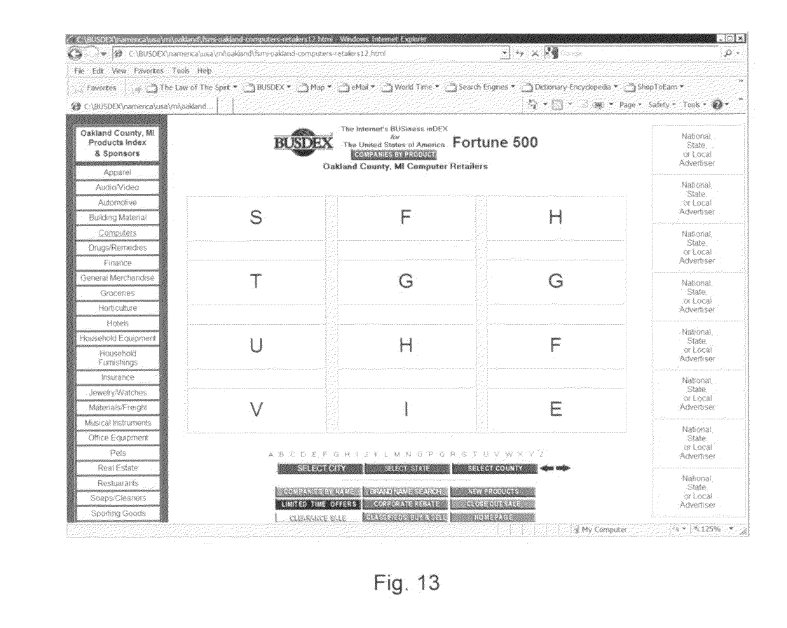

### FIG. 13 Coding

```
<HTML>
<HEAD><TITLE>BUSDEX Page Progressions Fig. 13</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>S</TD>
        <TD BGCOLOR=WHITE WIDTH=295 HEIGHT=77 ALIGN=CENTER
VALIGN=MIDDLE><FONT SIZE=6 FACE=“ARIAL”>F</TD>
        <TD BGCOLOR=WHITE WIDTH=295 HEIGHT=77 ALIGN=CENTER
VALIGN=MIDDLE><FONT SIZE=6 FACE=“ARIAL”>H</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>T</TD>
        <TD BGCOLOR=WHITE WIDTH=295 HEIGHT=77 ALIGN=CENTER
VALIGN=MIDDLE><FONT SIZE=6 FACE=“ARIAL”>G</TD>
        <TD BGCOLOR=WHITE WIDTH=295 HEIGHT=77 ALIGN=CENTER
VALIGN=MIDDLE><FONT SIZE=6 FACE=“ARIAL”>G</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>U</TD>
        <TD BGCOLOR=WHITE WIDTH=295 HEIGHT=77 ALIGN=CENTER
VALIGN=MIDDLE><FONT SIZE=6 FACE=“ARIAL”>H</TD>
        <TD BGCOLOR=WHITE WIDTH=295 HEIGHT=77 ALIGN=CENTER
VALIGN=MIDDLE><FONT SIZE=6 FACE=“ARIAL”>F</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>V</TD>
        <TD BGCOLOR=WHITE WIDTH=295 HEIGHT=77 ALIGN=CENTER
VALIGN=MIDDLE><FONT SIZE=6 FACE=“ARIAL”>I</TD>
        <TD BGCOLOR=WHITE WIDTH=295 HEIGHT=77 ALIGN=CENTER
VALIGN=MIDDLE><FONT SIZE=6 FACE=“ARIAL”>E</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page11.html”><IMG
SRC=“c:/busdex/images/arrow_lt.jpg” ALT=“Back”></A></TD>
    <TD ALIGN=RIGHT><A HREF=“c:/busdex/page13.html”><IMG
SRC=“c:/busdex/images/arrow_rt.jpg” ALT=“Forward”></A></TD>
</TR>
</TABLE>
</DIV>
</BODY>
</HTML>
```

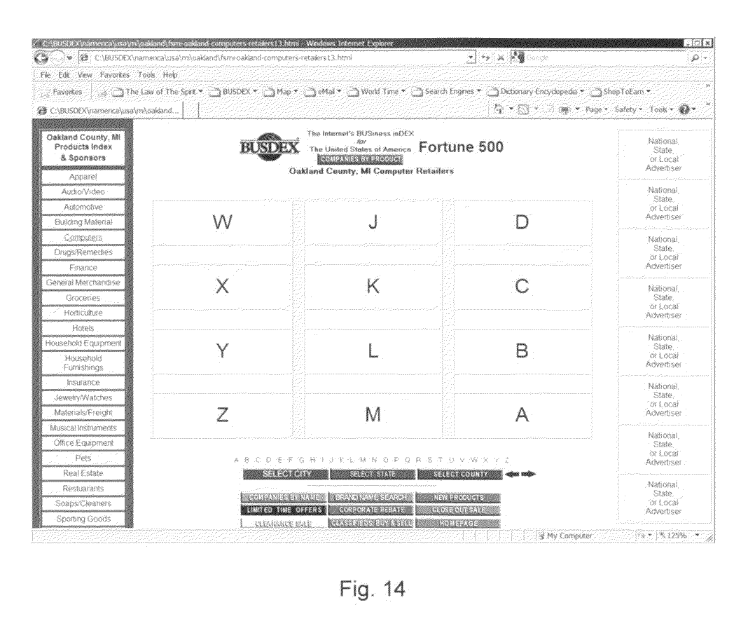

### FIG. 14 Coding

```
<HTML>
<HEAD><TITLE>BUSDEX Page Progressions Fig. 14</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>W</TD>
        <TD BGCOLOR=WHITE WIDTH=295 HEIGHT=77 ALIGN=CENTER
VALIGN=MIDDLE><FONT SIZE=6 FACE=“ARIAL”>J</TD>
        <TD BGCOLOR=WHITE WIDTH=295 HEIGHT=77 ALIGN=CENTER
VALIGN=MIDDLE><FONT SIZE=6 FACE=“ARIAL”>D</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>X</TD>
        <TD BGCOLOR=WHITE WIDTH=295 HEIGHT=77 ALIGN=CENTER
VALIGN=MIDDLE><FONT SIZE=6 FACE=“ARIAL”>K</TD>
        <TD BGCOLOR=WHITE WIDTH=295 HEIGHT=77 ALIGN=CENTER
VALIGN=MIDDLE><FONT SIZE=6 FACE=“ARIAL”>C</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>Y</TD>
        <TD BGCOLOR=WHITE WIDTH=295 HEIGHT=77 ALIGN=CENTER
VALIGN=MIDDLE><FONT SIZE=6 FACE=“ARIAL”>L</TD>
        <TD BGCOLOR=WHITE WIDTH=295 HEIGHT=77 ALIGN=CENTER
VALIGN=MIDDLE><FONT SIZE=6 FACE=“ARIAL”>B</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>Z</TD>
        <TD BGCOLOR=WHITE WIDTH=295 HEIGHT=77 ALIGN=CENTER
VALIGN=MIDDLE><FONT SIZE=6 FACE=“ARIAL”>M</TD>
        <TD BGCOLOR=WHITE WIDTH=295 HEIGHT=77 ALIGN=CENTER
VALIGN=MIDDLE><FONT SIZE=6 FACE=“ARIAL”>A</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page12.html”><IMG
SRC=“c:/busdex/images/arrow_lt.jpg” ALT=“Back”></A></TD>
    <TD ALIGN=RIGHT><A HREF=“c:/busdex/page1.html”><IMG
SRC=“c:/busdex/images/arrow_rt.jpg” ALT=“Forward”></A></TD>
</TR>
</TABLE>
</DIV>
</BODY>
</HTML>
```

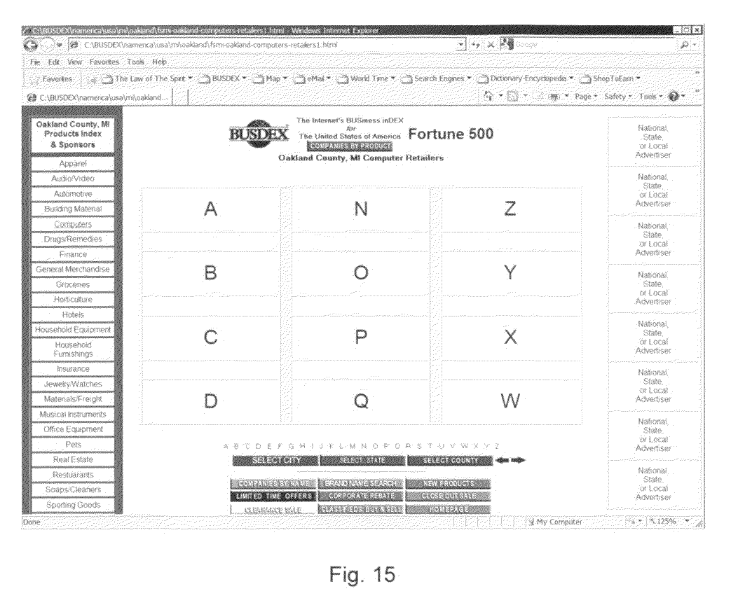

### FIG. 15 Coding

```
<HTML>
<HEAD><TITLE>BUSDEX Page Progressions Fig. 15</TITLE></HEAD>
<BODY BGCOLOR=WHITE LINK=“WHITE” VLINK=“WHITE” ALINK=“WHITE”><CENTER>
<DIV ALIGN=“CENTER”>
<TABLE BORDER=1 WIDTH=840 CELLPADDING=5>
    <TR>
        <TD BGCOLOR=WHITE WIDTH=295 HEIGHT=77 ALIGN=CENTER
VALIGN=MIDDLE><FONT SIZE=6 FACE=“ARIAL”>A</TD>
        <TD BGCOLOR=WHITE WIDTH=295 HEIGHT=77 ALIGN=CENTER
VALIGN=MIDDLE><FONT SIZE=6 FACE=“ARIAL”>N</TD>
        <TD BGCOLOR=WHITE WIDTH=295 HEIGHT=77 ALIGN=CENTER
VALIGN=MIDDLE><FONT SIZE=6 FACE=“ARIAL”>Z</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>B</TD>
        <TD BGCOLOR=WHITE WIDTH=295 HEIGHT=77 ALIGN=CENTER
VALIGN=MIDDLE><FONT SIZE=6 FACE=“ARIAL”>O</TD>
        <TD BGCOLOR=WHITE WIDTH=295 HEIGHT=77 ALIGN=CENTER
VALIGN=MIDDLE><FONT SIZE=6 FACE=“ARIAL”>Y</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>C</TD>
        <TD BGCOLOR=WHITE WIDTH=295 HEIGHT=77 ALIGN=CENTER
VALIGN=MIDDLE><FONT SIZE=6 FACE=“ARIAL”>P</TD>
        <TD BGCOLOR=WHITE WIDTH=295 HEIGHT=77 ALIGN=CENTER
VALIGN=MIDDLE><FONT SIZE=6 FACE=“ARIAL”>X</TD>
    </TR>
    <TR>
        <TD BGCOLOR=WHITE WIDTH=295 HEIGHT=77 ALIGN=CENTER
VALIGN=MIDDLE><FONT SIZE=6 FACE=“ARIAL”>D</TD>
        <TD BGCOLOR=WHITE WIDTH=295 HEIGHT=77 ALIGN=CENTER
VALIGN=MIDDLE><FONT SIZE=6 FACE=“ARIAL”>Q</TD>
        <TD BGCOLOR=WHITE WIDTH=295 HEIGHT=77 ALIGN=CENTER
VALIGN=MIDDLE><FONT SIZE=6 FACE=“ARIAL”>W</TD>
    </TR>
</TABLE>
<BR>
<TABLE WIDTH=50 ALIGN=CENTER BORDER=0 CELLPADDING=0 CELLSPACING=0>
<TR>
    <TD ALIGN=LEFT><A HREF=“c:/busdex/page13.html”><IMG
SRC=“c:/busdex/images/arrow_lt.jpg” ALT=“Back”></A></TD>
    <TD ALIGN=RIGHT><A HREF=“c:/busdex/page2.html”><IMG
SRC=“c:/busdex/images/arrow_rt.jpg” ALT=“Forward”></A></TD>
</TR>
</TABLE>
</DIV>
</BODY>
</HTML>
```

1-2. (canceled)

3. A bidirectional index comprising multiple columns of identical content, wherein at least two columns have an order of A to Z, wherein at least two columns begin at different points of the alphabet, wherein at least one column has an order of Z to A

4. The multiple columns of claim 1, wherein the columns are repetitious loops.
